(19) United States
(12) Patent Application Publication
(10) Pub. No.: US 2024/0089699 A1
(43) Pub. Date: Mar. 14, 2024

(54) REAL-TIME CROWD DATA APPROXIMATION SYSTEM

(71) Applicants: Lance Fein, Ft. Lauderdale, FL (US); Gregory Serfer, Ft. Lauderdale, FL (US)

(72) Inventors: Lance Fein, Ft. Lauderdale, FL (US); Gregory Serfer, Ft. Lauderdale, FL (US)

(21) Appl. No.: 17/944,324

(22) Filed: Sep. 14, 2022

(51) Int. Cl. H04W 4/029; H04W 4/02; H04W 4/021

(52) U.S. Cl. CPC H04W 4/029; H04W 4/021; H04W 4/023

(57) ABSTRACT

A system is disclosed enabling at least one device to determine and display or communicate real-time crowd data in an establishment or fixed geographic area by communicating with at least one local device at the establishment or fixed geographic area. The system may enable the use of GPS location functionality and other wireless protocols to approximate real-time crowd data in a geographic location. The system may enable pinging the at least one local device to receive real-time crowd data via a cloud database constructed and arranged to store and sync data received by the system.

### TECHNICAL FIELD

The embodiments described generally relate to a system for compiling, monitoring, manipulating, and delivering real-time crowd data to a plurality of users.

### BACKGROUND

Real-time crowd data and user or consumer “head count” in public places such as restaurants, bars, gyms, grocery stores, and retail stores is largely unavailable to the average consumer. Real-time crowd data is valuable to consumers for a variety of reasons including, but not limited to, reducing exposure to and the spread of infectious diseases, reducing overcrowding, avoiding long wait times for restaurants or bars, or similar situations. Currently, there is an unresolved need for real-time crowd data deliverable to users on their personal devices such that users may make well informed decisions relating to reducing exposure to and the spread of infectious diseases, reducing overcrowding, avoiding long wait times for restaurants or bars, or similar situations.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments disclosed herein provide for a system enabling at least one device to determine and display or communicate real-time crowd data in an establishment or fixed geographic area by communicating with at least one local device at the establishment or fixed geographic area. The system may enable the use of GPS location functionality and other wireless protocols to approximate real-time crowd data in a geographic location. The system may enable pinging the at least one local device to receive real-time crowd data via a cloud database constructed and arranged to store and sync data received by the system.

A mobile device may include a display; at least one user computing device in operable connection with a network; a memory that stores computer-executable components; a processor that executes the computer-executable components stored in the memory, wherein the computer-executable components may include a real-time crowd data approximation application in communication with the computing device wherein the application may be constructed and arranged to, in response to a user request, enable the at least one user computing device to display real-time crowd data in an establishment or fixed geographic area as received from and approximated by a cloud-based server system on the network.

A real-time crowd data approximation system may include at least one user computing device in operable connection with a network; a cloud-based server system in operable communication with the network; a memory that stores computer-executable components; a processor that executes the computer-executable components stored in the memory, wherein the computer-executable components may include an application in communication with the computing device wherein the application may be constructed and arranged to communicate the geographic location of the user computing device to the cloud-based server system; receive user input of a geographic location; receive user input of a request for real-time crowd data; communicate each of the user inputs to the crowd-based server system; approximate real-time crowd data at the user input geographic location; communicate aggregated real-time crowd data to the at least one user computing device from the network relevant to the geographic location; and display or communicate the real-time crowd data to the user via the at least one user computing device.

A real-time crowd data approximation system may include at least one user computing device in operable connection with a network; a cloud-based server system in operable communication with the network; a memory that stores computer-executable components; a processor that executes the computer-executable components stored in the memory, wherein the computer-executable components may include providing an application in communication with the computing device wherein the application may be constructed and arranged to communicate the geographic location of the user computing device to the cloud-based server system; receive user input of a geographic location; receive user input of a request for real-time crowd data; receive user input of a real-time crowd data threshold; communicate each of the user inputs to the crowd-based server system; approximate real-time crowd data at the user input geographic location; compare and correlate approximated real-time crowd data at the user input geographic location to the user input of a real-time crowd data threshold; communicate aggregated real-time crowd data to the at least one user computing device from the network relevant to the geographic location; display or communicate the real-time crowd data to the user via the at least one user computing device; and provide a notification to the at least one user computing device when the approximated real-time crowd data is below, meets, or exceeds the user input of a real-time crowd data threshold.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the system, according to some embodiments described herein;

FIG. 2 illustrates a graphical user interface according to some embodiments described herein;

FIG. 3 illustrates a graphical user interface according to some embodiments described herein;

FIG. 4 illustrates a graphical user interface according to some embodiments described herein;

FIG. 5 illustrates a graphical user interface according to some embodiments described herein;

FIG. 6 illustrates a graphical user interface according to some embodiments described herein;

FIG. 7 illustrates a graphical user interface according to some embodiments described herein;

FIG. 8 illustrates a flow diagram illustrating an example process of a system for determining and communicating real-time crowd data in an establishment or fixed geographic area;

FIG. 9 illustrates a flow diagram illustrating an example process of a system for determining and communicating real-time crowd data in an establishment or fixed geographic area; and

FIG. 10 illustrates a flow diagram illustrating an example process of a system for determining and communicating real-time crowd data in an establishment or fixed geographic area.

### DETAILED DESCRIPTION

The specific details of a single embodiment or variety of embodiments and variations described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the term “user(s)” may refer to individual persons, groups, businesses, establishments, government bodies, or any person or group of persons or any entity.

In this disclosure, “GUI” may refer to any graphical user interface that includes at least one interactive component between a user and the application. A GUI may include a plurality of fillable fields, clickable buttons, database displays, or the like. A GUI may be adaptable for use on several devices such as computers, phones, smart devices, tablets, laptops, televisions, or the like.

In this disclosure, the terms “device,” “devices,” “handheld device,” or “smart device” may include computers, phones, smart phones, tablets, laptops, televisions, smart speakers, smart cars, thermostats, locks, cameras, appliances, watches, or devices broadly included in the concept of the “internet of things.” Devices may be connected or in communication with other devices via any number of wireless protocols and non-wireless protocols. Wireless protocols may include, broadly, wireless internet, Wi-Fi, Li-Fi, near-field communication, ultra-high frequency radio, or the like. Devices may be connected or in communication with other devices such as local computers, phones, smart phones, tablets, laptops, televisions as well devices not considered local.

In this disclosure, the term “real-time” refers generally to response times relating to computing devices and the rate at which a computing device may accomplish a process, step, or executable function. The term “real-time,” when used as an adjective or modifier of an additional word or term should be understood to include both instantly accurate as well as approximations. That is, “real-time” as used in this disclosure, should be understood to include approximations of data and responses to user inputs within a system within a specified time interval which may not necessarily be instantaneous.

In this disclosure, terms “store,” “storage,” “data store,” “data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

In this disclosure, “cloud” or “cloud storage” or “cloud-based system” may refer, generally, to software and services operating and communicating through the internet rather than on a local device. A cloud-based server system may enable various user devices to access the stored data on a server via the internet. The cloud or cloud-based services may enable a user or users to access the same or different files and applications from virtually any device. The files or applications being accessed and used may be stored on servers, computers, or any local or distant computer device. User devices may access the files or applications stored in the cloud via the Internet and most commonly via a wireless protocol as previously described herein. As a non-limiting example, A server in communication with the world wide web may store data relating to geo-locations of restaurants, service providers, businesses, and other entities. Similarly, the cloud may be constructed and arranged to receive data from user devices and store it on the server or servers. User data may also be communicated to various user devices as desired.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In this disclosure, the various embodiments may be a system, method, apparatus, and/or computer program product at any possible technical detail level of integration. A computer application product can include, among other things, a computer-readable storage medium having computer-readable program instructions thereon for causing a processor to carry out aspects of the present disclosure.

In general, the embodiments described herein relate to a system enabling at least one device to determine and display or communicate real-time crowd data of an establishment or fixed geographic area. The system may allow a device to determine the number of local devices using the same system to provide real-time crowd data in an establishment or fixed geographic area. The system may provide for establishing threshold limits on real-time crowd data such that a user or users of the device may receive notifications from the system regarding real-time crowd data below, at, or exceeding a threshold limit.

The system may include communicating at least one user's geographic location as determined by GPS functionality on the at least one user's device to a cloud database server system. The system may include communicating a plurality of user's geographic respective locations as determined by GPS functionality on each of the user's devices to a cloud database server system. The cloud-based server system may be constructed and arranged to receive, compile, manipulate, and communicate at least some portion of user's geographic respective locations to at least one user's device routinely or when requested by a user. The system may also be constructed and arranged to receive, compile, manipulate, and communicate geographic location data relating to establishments such as restaurants, bars, retail stores, etc. received from several available sources such as, for example, internet databases. The system may be constructed and arranged to receive user requests for real-time crowd data in an establishment or fixed geographic area and the system may provide said crowd data from the cloud-based database to be displayed on the user's device.

Real-time crowd data may be a number or numbers of persons in an establishment and displayed as such on a user's device. Real-time crowd data may be displayed as a list featuring nearby establishments or establishments in a user defined geographic area. Real-time crowd data may be displayed as a crowd density map featuring data displayed in a heat-map style, as a dot distribution map or dot density map, or any other suitable thematic map. When viewed as a crowd density map on a user's device, the map may be scrollable such that a user may search various areas of the map for crowd density. The examples provided as to how real-time crowd data may be displayed on a device should not be considered limiting and this disclosure contemplates various other means by which data may be presented and displayed.

A system enabling at least one device to determine and display or communicate real-time crowd data in an establishment or fixed geographic area may also be constructed and arranged to ping local devices based on ultra-high frequency radio wave connectivity e.g. BlueTooth®. The system may ping local devices based on a variety of wireless protocols such as wireless internet, Wi-Fi, Li-Fi, near-field communication, ultra-high frequency radio, or the like. The system may ping at least one device or a plurality of devices local to the user identified geographic via a wireless protocol to determine at least one local device count data and communicate the local device count data to a cloud-based server system in communication with a network. Data received by the cloud-based server system may be compiled and manipulated to approximate real-time crowd data at the user identified geographic location. The system may ping local devices and communicate the geolocation of the pinged local devices to the cloud-based server system such that pinged local devices may be included in the compiled real-time crowd data.

A system enabling at least one device to determine and display or communicate real-time crowd data in an establishment or fixed geographic area may also include a reminder module. The reminder module may be constructed and arranged to receive user input of a real time crowd data threshold such as a maximum number of occupants at a particular geographic location. The system may be constructed in range to compare and correlate approximated real-time crowd data to the user inputted real-time crowd data threshold. The system may be constructed and arranged to provide a notification such as a pop-up notification, audible signal, or other notification that the approximated real time data is below, at, or more than the user input of a real time crowd data threshold. In this way, the system may alert a user not only of approximated real-time crowd data but also if the real time crowd data is below a fixed value, at a fixed value, or above a fixed value. Therefore, the user may use the system to receive information to assist in deciding if a geographic location has low occupancy or maybe overcrowded.

A system enabling at least one device to determine and display or communicate real-time crowd data in an establishment or fixed geographic area may also include a use case for establishment that may permit establishments such as restaurants, bars, gyms, etc. to view and monitor real-time crowd data in their respective establishment. An establishment use case may include the capacity to identify establishment-owned devices such as smart-cash registers, computers, laptops, phones, etc. such that establishment-owned devices are not counted in the aggregation of real-time crowd data to provide more accurate customer crowd data information to the establishment.

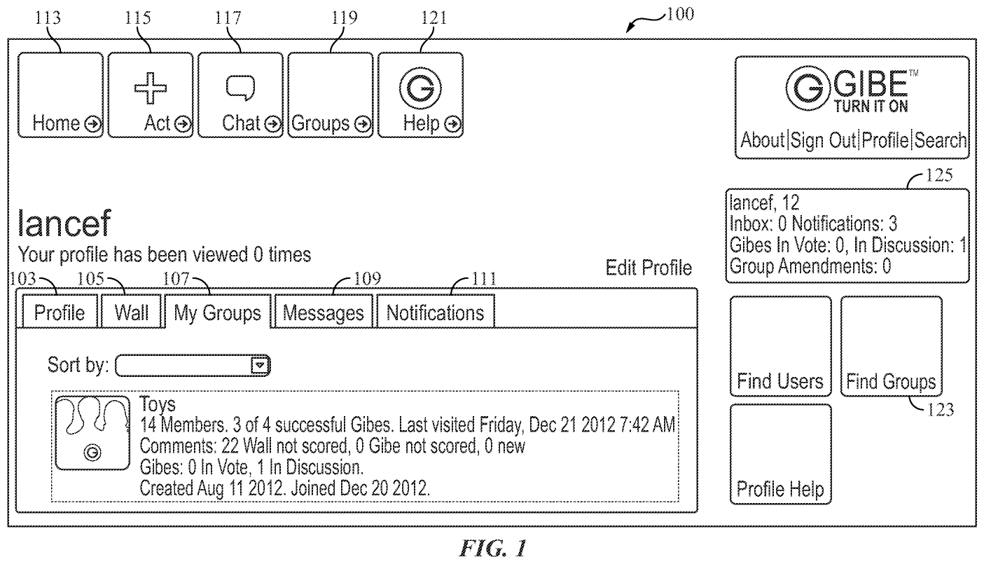

FIG. 1 depicts a diagram showing a variation of a real-time crowd data approximation system 100. The real-time crowd data approximation system 100 may include a cloud-based server system 114 constructed and arranged to communicate with at least one user device 116 or a plurality of user devices 118, 116 via cloud computing 112. At least one user device 118 may include GPS functionality and be in communication 132 with a global positioning satellite 120 such that the geolocation of the at least one user device 118 may be determined. The geolocation of the at least one user device 118 may be communicated 128 to the cloud-based server system 114 via cloud computing 116. A plurality of user devices 116, 118 may communicate their geolocation to the cloud-based server system 118 via cloud computing 112 in this way. The cloud-based server system 114 may communicate data 130 relating to real-time crowd data, news, infectious diseases, chats, blogs, reminders, or the like via cloud computing 112 to the user devices 116, 118 individual or together. User devices 116 may communicate requests 124 for real-time crowd data at user identified locations or user specified radii of a location. Real-time crowd data approximation system 100 may, in response to user requests or according to routine schedule, communicate real-time crowd data to the user device 116 and presented to the user.

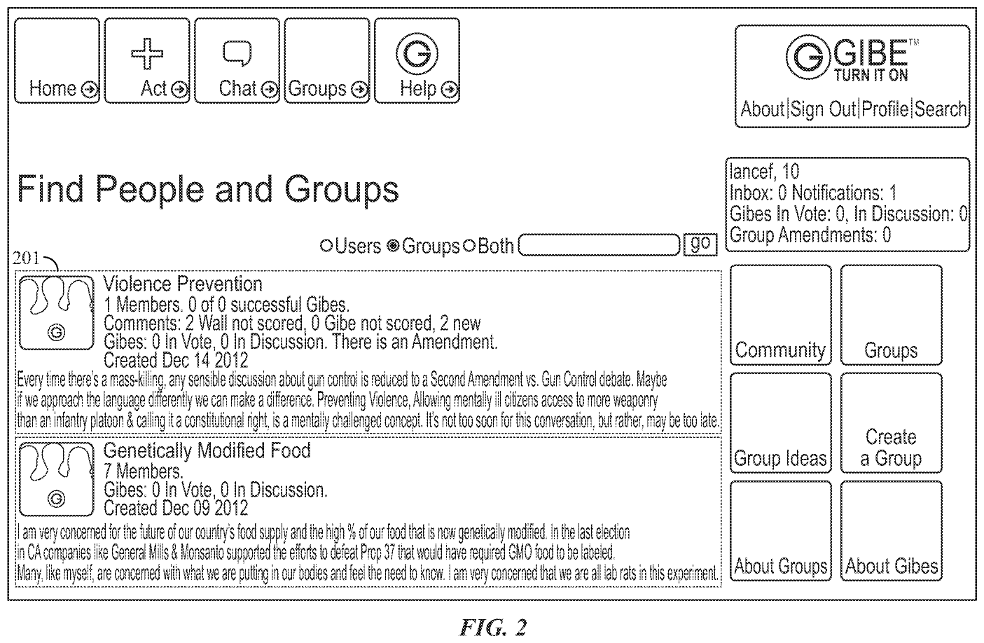

FIG. 2 depicts a GUI 210 of a real-time crowd data approximation system 200 that may be constructed and arranged to enable at least one device to determine and display or communicate real-time crowd data in an establishment or fixed geographic area.

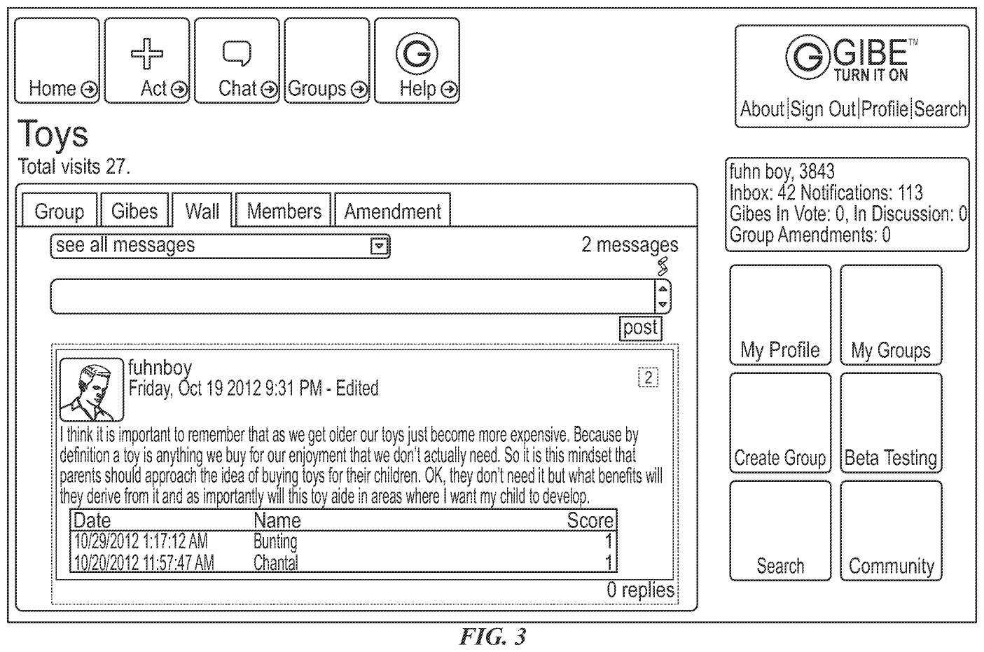

FIG. 3 depicts a GUI 310 of a real-time crowd data approximation system 300 that may be constructed and arranged to enable at least one device to determine and display or communicate real-time crowd data in an establishment or fixed geographic area. The GUI 310 may be used to include and display calendar and time information 316, scheduled reminder information 314, nearby device information 318, location information 312, and additional information 320, 322 relating to the real-time crowd data approximation system 300.

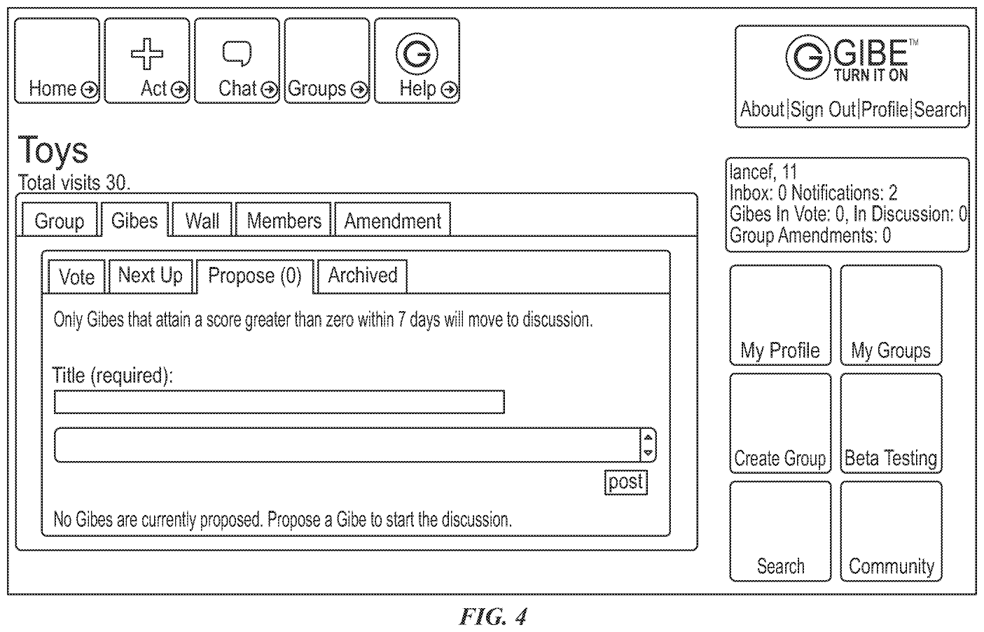

FIG. 4 depicts a GUI of a real-time crowd data approximation system that may be constructed and arranged to enable at least one device to determine and display or communicate real-time crowd data in an establishment or fixed geographic area. The GUI may be used to allow a user to establish reminders via a reminder module 400. The reminder module 400 may receive reminders set by a user dependent on time and date information 410, reminders set by a user dependent on geographic location 412, and reminders set by a user dependent on the real-time crowd data approximation and nearby device count 414. In this way, the device may receive user input of a real-time crowd data threshold such as a desired maximum number of occupants at a restaurant, compare and correlate approximated real-time crowd data at the user input geographic location to the user input of a real-time crowd data threshold; and provide a notification to the at least one user computing device when the approximated real-time crowd data is below, meets, or exceeds user input of a real-time crowd data threshold.

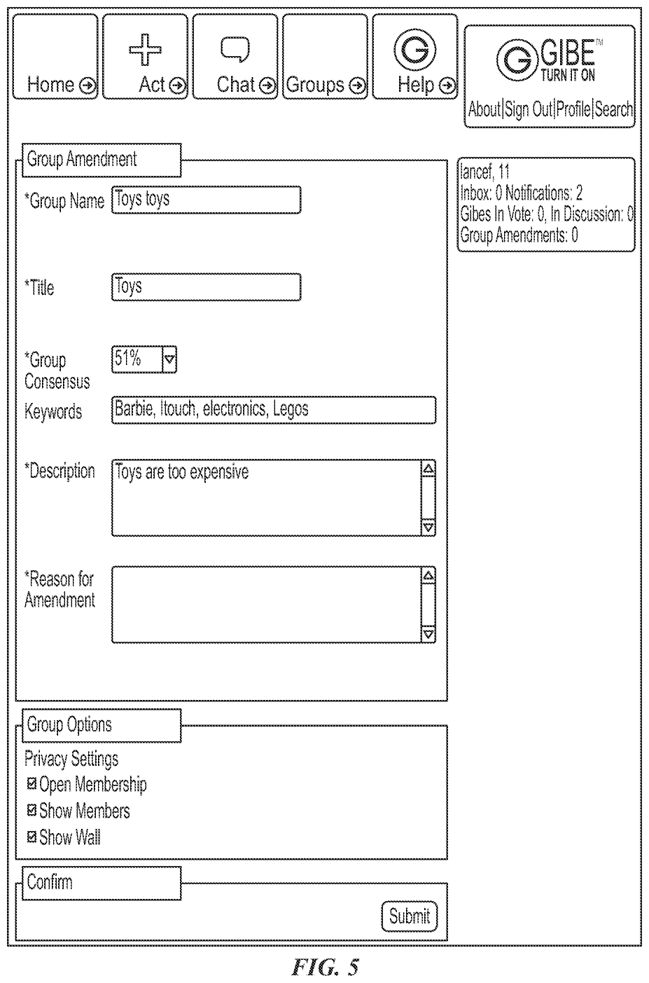

FIG. 5 depicts a GUI of a real-time crowd data approximation system that may be constructed and arranged to enable at least one device to determine and display or communicate real-time crowd data in an establishment or fixed geographic area. The GUI may be used to allow a user to establish reminders via a reminder module 500 that may receive user inputs 510 such as reminder title, repetition occurrence, date, time, and additional optional notification settings.

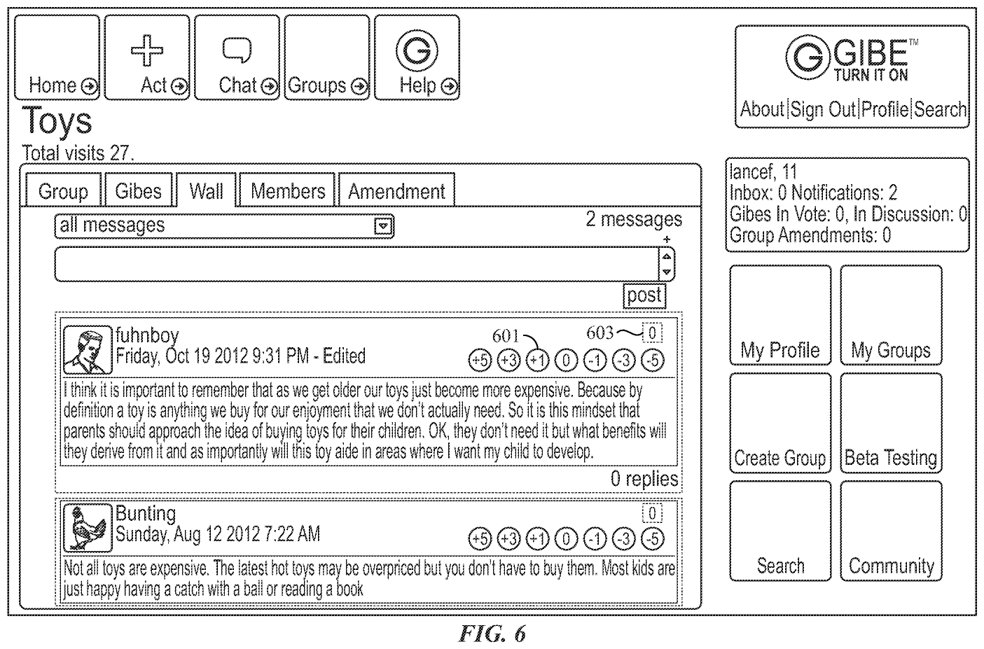

FIG. 6 depicts a GUI of a real-time crowd data approximation system 600 that may be constructed and arranged to enable at least one device to determine and display or communicate real-time crowd data in an establishment or fixed geographic area. The GUI may be used to allow a user to toggle reminders on or off. The GUI may be used to allow a user to establish safe spaces. Safe spaces may be user defined geographic locations that may correspond to established reminders associated with each safe space. Safe spaces may be user defined geographic locations that may enable a user's device to automatically disable communicating their GPS location to the real-time crowd data approximation system such that a user's device location may remain hidden while in a safe space.

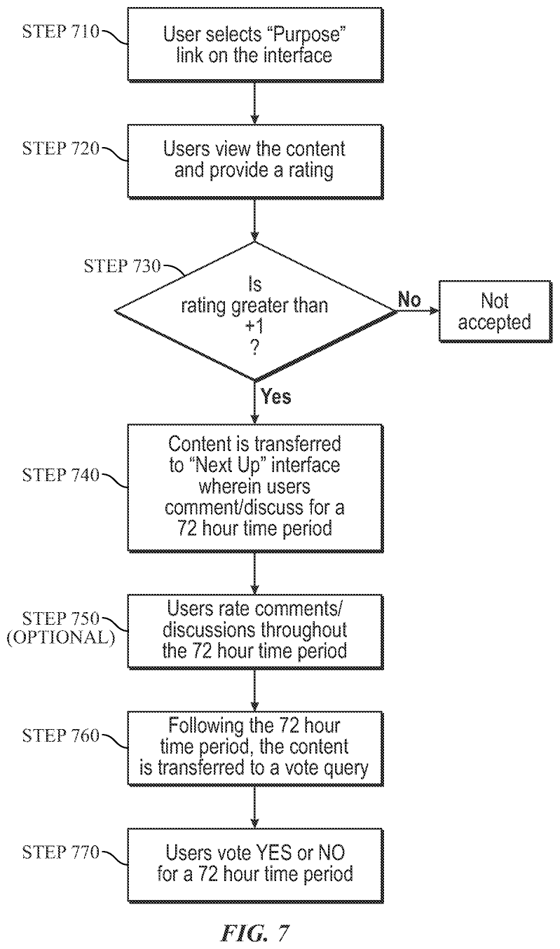

FIG. 7 depicts a GUI of a real-time crowd data approximation system 700 that may be constructed and arranged to enable at least one device to determine and display or communicate real-time crowd data in an establishment or fixed geographic area. The GUI may be used to allow a user to share 710 their individual location data, geographic location data relating to establishments, as well as sharing information relating to the system with other users via various social media platforms.

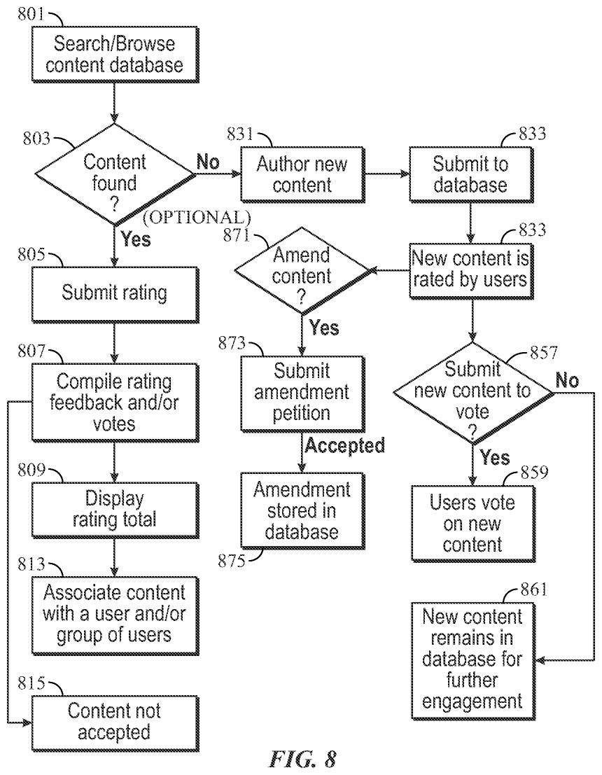

FIG. 8 is a flow diagram illustrating an example process 800 of a system enabling at least one device to determine and display or communicate real-time crowd data in an establishment or fixed geographic area via an application on a user device. Step 801 may include establishing the communication of information between a cloud-based server system and at least one iteration of the application on a user device. Step 810 may include providing a cloud-based server system constructed and arranged to communicate with at least one iteration of the application on a user device. Step 820 may include providing an application on two or more user devices, the application being constructed and arranged to communicate location data, such as via GPS functionality, to the cloud-based server system. Step 830 may include providing local ping functionality via the application to user devices such that user devices not employing the application may be pinged and recognized by user devices utilizing the application and compiled in the real-time crowd data. Step 840 may include communicating location data from user devices to the cloud-based server system including data relating to GPS location of user devices utilizing the application and user devices detected via ping. Step 850 may include receive user location data in the cloud-based server system. Step 860 may include receiving user requests via the application for real-time crowd data at at least one geographic location. Step 870 may include providing real-time crowd data via the application to a user on their user device.

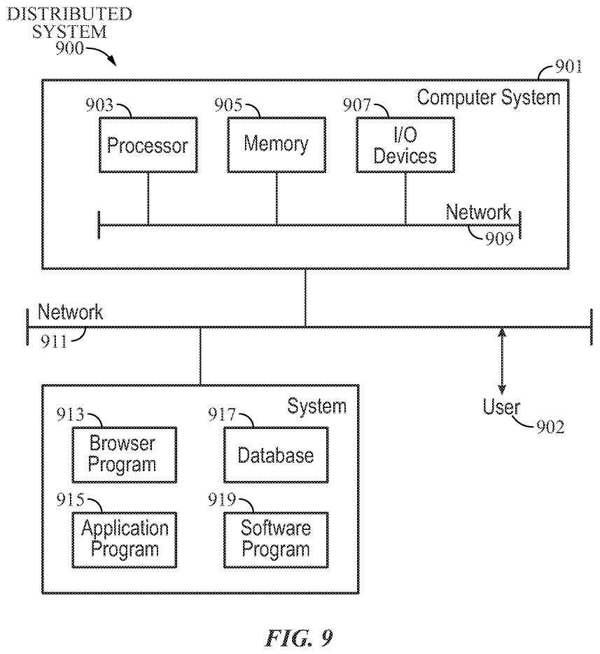

FIG. 9 is a flow diagram illustrating an example process 900 of a system enabling at least one device to determine and display or communicate real-time crowd data in an establishment or fixed geographic area via an application on a user device. Step 901 may include establishing the communication of information between a cloud-based server system and at least one iteration of the application on a user device. Step 910 may include providing a cloud-based server system constructed and arranged to communicate with at least one iteration of the application on a user device. Step 920 may include providing an application on two or more user devices, the application being constructed and arranged to communicate location data, such as via GPS functionality, to the cloud-based server system. Step 930 may include providing local ping functionality via the application to user devices such that user devices not employing the application may be pinged and recognized by user devices utilizing the application and compiled in the real-time crowd data. Step 940 may include communicating location data from user devices to the cloud-based server system including data relating to GPS location of user devices utilizing the application and user devices detected via ping. Step 950 may include receive user location data in the cloud-based server system. Step 960 may include receiving user requests via the application for real-time crowd data at at least one geographic location. Step 980 may include providing real-time crowd data via the application to a user on their user device. Step 970 may include receiving user requests for notification when a user identified geographic location contains a user identified threshold count of real-time crowd count. Step 990 may include providing a notification to a user's device when the user identified geographic location contains a user identified threshold count of real-time crowd count.

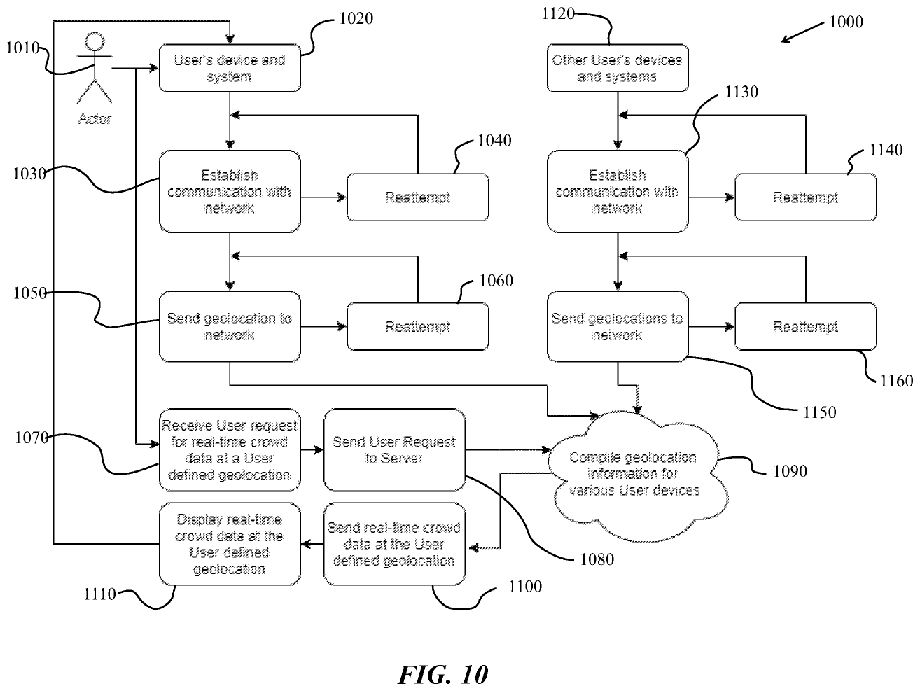

In reference to FIG. 10, a flowchart of a use case diagram depicts the manner in which a user may use the system to send, receive, and view real-time crowd data in an establishment or fixed geographic area via an application on a user device. A real-time crowd data approximation system 1000 may enable a user 1010 to utilize their device 1020 to receive real-time crowd data at a user specified location. When enabled, the user's device may establish communication with a network 1030. Failed connections to the network 1030 may be reattempted 1040. The user's device may communicate the geolocation 1050 of the device to a cloud-based server system 1090. Failed attempts to send the geolocation of the user device 1020 to the cloud-based server system 1090 may be reattempted 1060. Similarly, the system 1000 may enable additional users to utilize their device 1120 to receive real-time crowd data at a user specified location. When enabled, the additional user's device may establish communication with a network 1130. Failed connections to the network 1130 may be reattempted 1140. The additional user's devices may communicate the geolocation 1150 of the devices to a cloud-based server system 1090. Failed attempts to send the geolocation of the additional users devices to the cloud-based server system 1090 may be reattempted 1160. The system 1000 may receive user requests for real-time crowd data at user identified geolocations 1070 which may be communicated 1080 to the cloud-based server system 1090. The cloud-based server system 1090 may receive, compile, aggregate, manipulate, and provide cloud computing services and functionality such that data from various user devices may be utilized to provide real-time crowd data. The cloud-based server system 1090 may send real-time crowd data 1100 relevant to the user requests for real-time crowd data at the user identified geolocations 1070. The real-time crowd data may be displayed 1110 on the user's device 1020.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.
According to Variation 1, a mobile device may include a display; at least one user computing device in operable connection with a network; a memory that stores computer-executable components; a processor that executes the computer-executable components stored in the memory, wherein the computer-executable components may include a real-time crowd data approximation application in communication with the computing device wherein the application may be constructed and arranged to, in response to a user request, enable the at least one user computing device to display real-time crowd data in an establishment or fixed geographic area as received from the network.
Variation 2 may include a mobile device as set forth in variation 1, wherein enabling the at least one user computing device to display real-time crowd data in a user identified geographic area as received from the network may include the steps of pinging at least one device local to the user identified geographic via a wireless protocol to determine at least one local device count data; communicating the at least one local device count data to a cloud-based server system in communication with the network; approximating real-time crowd data at the user identified geographic location by compiling the at least one local device count data; communicating real-time crowd data from the cloud-based server system via the network to the mobile device; and displaying the real-time crowd data on the mobile device.
Variation 3 may include a mobile device as set forth in any of variations 1 through 2 and further may include a cloud-based server system in operable communication with the at least one user computing device via the network.
Variation 4 may include a mobile device as set forth in any of variations 1 through 3 and further may include a plurality of additional mobile devices, each additional mobile device being associated with additional individual users, establishments, or locations.
Variation 5 may include a mobile device as set forth in any of variations 1 through 4 wherein the application may be constructed and arranged to communicate the geographic location of the mobile device to the cloud-based server system.
Variation 6 may include a mobile device as set forth in any of variations 1 through 5 wherein the application may be constructed and arranged to communicate the geographic location of each additional mobile device to the cloud-based server system.
Variation 7 may include a mobile device as set forth in any of variations 1 through 6 wherein the application may be constructed and arranged to receive a first user input request for real-time crowd data and a second user input may include a user identified geographic location.
Variation 8 may include a mobile device as set forth in any of variations 1 through 7 wherein the application may be constructed and arranged to compile and approximate real-time crowd data at a user identified geographic location.
Variation 9 may include a mobile device as set forth in any of variations 1 through 8 wherein the application may be constructed and arranged to communicate to the mobile device and display on the display requested real-time crowd data at a user identified geographic location.
Variation 10 may include a mobile device as set forth in any of variations 1 through 9 wherein the application may include a reminder module constructed and arranged to communicate to receive user input of a real-time crowd data threshold; compare and correlate approximated real-time crowd data at the user input geographic location to the user input of a real-time crowd data threshold; and provide a notification to the at least one user computing device when the approximated real-time crowd data may include below, meets, or exceeds user input of a real-time crowd data threshold.
Variation 11 may include real-time crowd data approximation system that may include at least one user computing device in operable connection with a network; a cloud-based server system in operable communication with the network; a memory that stores computer-executable components; a processor that executes the computer-executable components stored in the memory, wherein the computer-executable components may include an application in communication with the computing device wherein the application may be constructed and arranged to communicate the geographic location of the user computing device to the cloud-based server system; receive user input of a geographic location; receive user input of a request for real-time crowd data; communicate each of the user inputs to the crowd-based server system; approximate real-time crowd data at the user input geographic location; communicate aggregated real-time crowd data to the at least one user computing device from the network relevant to the geographic location; and display or communicate the real-time crowd data to the user via the at least one user computing device.
Variation 12 may include a real-time crowd data approximation system as set forth variation 11 and further may include a plurality of additional computing devices, each additional computing device being associated with additional individual users, establishments, or locations.
Variation 13 may include a real-time crowd data approximation system as set forth in any of variations 11 through 12 wherein the system may be constructed and arranged to communicate the geographic location of each additional computing device to the cloud-based server system.
Variation 14 may include a real-time crowd data approximation system as set forth in any of variations 11 through 13 and further may include a reminder module.
Variation 15 may include a real-time crowd data approximation system as set forth in variation 14 wherein the reminder module may be constructed and arranged to receive user input of a real-time crowd data threshold; compare and correlate approximated real-time crowd data at the user input geographic location to the user input of a real-time crowd data threshold; and provide a notification to the at least one user computing device when the approximated real-time crowd data may include below, meets, or exceeds user input of a real-time crowd data threshold.
Variation 16 may include a method that may include providing a real-time crowd data approximation system may include at least one user computing device in operable connection with a network; a cloud-based server system in operable communication with the network; a memory that stores computer-executable components; a processor that executes the computer-executable components stored in the memory, wherein the computer-executable components may include providing an application in communication with the computing device wherein the application may be constructed and arranged to communicate the geographic location of the user computing device to the cloud-based server system; receive user input of a geographic location; receive user input of a request for real-time crowd data; receive user input of a real-time crowd data threshold; communicate each of the user inputs to the crowd-based server system; approximate real-time crowd data at the user input geographic location; compare and correlate approximated real-time crowd data at the user input geographic location to the user input of a real-time crowd data threshold; communicate aggregated real-time crowd data to the at least one user computing device from the network relevant to the geographic location; display or communicate the real-time crowd data to the user via the at least one user computing device; and provide a notification to the at least one user computing device when the approximated real-time crowd data may include below, meets, or exceeds user input of a real-time crowd data threshold. Variation 17 may include a method as set forth in variation 16 wherein approximating real-time crowd data at the user input geographic location may include pinging a plurality of devices local to the user input geographic via a wireless protocol to determine real-time crowd data and communicating the real-time crowd data to the cloud-based server system.
Variation 18 may include a method as set forth in any of variations 16 through 17 and may further include a plurality of additional computing devices, each additional computing device being associated with additional individual users, establishments, or locations.
Variation 19 may include a method as set forth in any of variations 16 through 17 wherein the system may be constructed and arranged to communicate the geographic location of each additional computing device to the cloud-based server system.
Variation 20 may include a method as set forth in any of variations 16 through 19 further comprising a reminder module constructed and arranged to perform the steps of receiving user input of a real-time crowd data threshold; comparing and correlating approximated real-time crowd data at the user input geographic location to the user input of a real-time crowd data threshold; and providing a notification to the at least one user computing device when the approximated real-time crowd data is below, meets, or exceeds user input of a real-time crowd data threshold.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A mobile device comprising:
a display;
at least one user computing device in operable connection with a network;
a memory that stores computer-executable components;
a processor that executes the computer-executable components stored in the memory, wherein the computer-executable components comprise:
a real-time crowd data approximation application in communication with the computing device wherein the application is constructed and arranged to, in response to a user request, enable the at least one user computing device to display real-time crowd data in a user identified geographic area as received from the network.

2. The mobile device as set forth in claim 1, wherein enabling the at least one user computing device to display real-time crowd data in a user identified geographic area as received from the network comprises:
pinging at least one device local to the user identified geographic via a wireless protocol to determine at least one local device count data;
communicating the at least one local device count data to a cloud-based server system in communication with the network;
approximating real-time crowd data at the user identified geographic location by compiling the at least one local device count data;
communicating real-time crowd data from the cloud-based server system via the network to the mobile device; and
displaying the real-time crowd data on the mobile device.

3. The mobile device as set forth in claim 1, further comprising a cloud-based server system in operable communication with the at least one user computing device via the network.

4. The mobile device as set forth in claim 3, further comprising a plurality of additional mobile devices, each additional mobile device being associated with additional individual users, establishments, or locations.

5. The mobile device as set forth in claim 1, wherein the application is constructed and arranged to communicate the geographic location of the mobile device to the cloud-based server system.

6. The mobile device as set forth in claim 1, wherein the application is constructed and arranged to communicate the geographic location of each additional mobile device to the cloud-based server system.

7. The mobile device as set forth in claim 1, wherein the application is constructed and arranged to receive a first user input request for real-time crowd data at a second user input comprising a user identified geographic location.

8. The mobile device as set forth in claim 1, wherein the application is constructed and arranged to compile and approximate real-time crowd data at a user identified geographic location.

9. The mobile device as set forth in claim 1, wherein the application is constructed and arranged to communicate to the mobile device and display on the display requested real-time crowd data at a user identified geographic location.

10. The mobile device as set forth in claim 1, further comprising a reminder module constructed and arranged to:
receive user input of a real-time crowd data threshold;
compare and correlate approximated real-time crowd data at the user input geographic location to the user input of a real-time crowd data threshold; and
provide a notification to the at least one user computing device when the approximated real-time crowd data is below, meets, or exceeds user input of a real-time crowd data threshold.

11. A real-time crowd data approximation system comprising:
at least one user computing device in operable connection with a network;
a cloud-based server system in operable communication with the network;
a memory that stores computer-executable components;
a processor that executes the computer-executable components stored in the memory, wherein the computer-executable components comprise:
an application in communication with the computing device wherein the application is constructed and arranged to:
communicate the geographic location of the user computing device to the cloud-based server system;
receive user input of a geographic location;
receive user input of a request for real-time crowd data;
communicate each of the user inputs to the crowd-based server system;
approximate real-time crowd data at the user input geographic location;
communicate aggregated real-time crowd data to the at least one user computing device from the network relevant to the geographic location; and
display or communicate the real-time crowd data to the user via the at least one user computing device.

12. The real-time crowd data approximation system as set forth in claim 11, further comprising a plurality of additional computing devices, each additional computing device being associated with additional individual users, establishments, or locations.

13. The real-time crowd data approximation system as set forth in claim 12, wherein the system is constructed and arranged to communicate the geographic location of each additional computing device to the cloud-based server system.

14. The real-time crowd data approximation system as set forth in claim 11, further comprising a reminder module.

15. The real-time crowd data approximation system as set forth in claim 14, wherein the reminder module is constructed and arranged to:
receive user input of a real-time crowd data threshold;
compare and correlate approximated real-time crowd data at the user input geographic location to the user input of a real-time crowd data threshold; and
provide a notification to the at least one user computing device when the approximated real-time crowd data is below, meets, or exceeds user input of a real-time crowd data threshold.

16. A method comprising:
providing a real-time crowd data approximation system comprising:
at least one user computing device in operable connection with a network;
a cloud-based server system in operable communication with the network;
a memory that stores computer-executable components;
a processor that executes the computer-executable components stored in the memory, wherein the computer-executable components comprise:
providing an application in communication with the computing device wherein the application is constructed and arranged to:
communicate the geographic location of the user computing device to the cloud-based server system;
receive user input of a geographic location;
receive user input of a request for real-time crowd data;
communicate each of the user inputs to the crowd-based server system;
approximate real-time crowd data at the user input geographic location;
communicate real-time crowd data to the at least one user computing device from the network relevant to the geographic location; and
display or communicate the real-time crowd data to the user via the at least one user computing device.

17. The real-time crowd data approximation system as set forth in claim 15, wherein approximating real-time crowd data at the user input geographic location comprises:
pinging a plurality of devices local to the user input geographic via a wireless protocol to determine real-time crowd data; and
communicating the real-time crowd data to the cloud-based server system.

18. The real-time crowd data approximation system as set forth in claim 15, further comprising a plurality of additional computing devices, each additional computing device being associated with additional individual users, establishments, or locations.

19. The real-time crowd data approximation system as set forth in claim 16, wherein the system is constructed and arranged to communicate the geographic location of each additional computing device to the cloud-based server system.

20. The real-time crowd data approximation system as set forth in claim 15, further comprising a reminder module constructed and arranged to:
receive user input of a real-time crowd data threshold;
compare and correlate approximated real-time crowd data at the user input geographic location to the user input of a real-time crowd data threshold; and
provide a notification to the at least one user computing device when the approximated real-time crowd data is below, meets, or exceeds user input of a real-time crowd data threshold.
